(19) United States
(12) Patent Application Publication
(10) Pub. No.: US 2026/0337886 A1
(43) Pub. Date: Oct. 29, 2026

(54) PAPER-BOARD BASED DISPOSABLE CUP ARRANGED WITH AN INTERIOR LAYER WITH LOW PPS-VALUE

(71) Applicant: Stora Enso OYJ, Helsinki (FI)

(72) Inventors: Sami-Seppo Ovaska, Lappeenranta (FI); Kimmo Nevalainen, Kotka (FI)

(73) Assignee: Stora Enso OYJ, Helsinki (FI)

(21) Appl. No.: 19/103,930

(22) PCT Filed: Jul. 13, 2023
(86) PCT No.: PCT/IB2023/057176

§ 371 Date: Feb. 14, 2025

(30) Foreign Application Priority Data
Aug. 16, 2022 (SE) 2230265-7

(51) Int. Cl. D21H 19/82; B65D 3/28; D21H 19/38

(52) U.S. Cl. CPC D21H 19/826; B65D 3/28; D21H 19/385

(57) ABSTRACT

The present invention relates to a paperboard-based disposable cup, said paperboard-based disposable cup being formed of a paperboard-based laminate, wherein a first side of the paperboard-based laminate forming an inside surface of the paperboard-based disposable cup comprises a pigment coating layer having a grammage in the range of 10-20 g/m² and an outermost polymer coating layer having a grammage in the range of 5-25 g/m², wherein the inside surface of the paperboard-based disposable cup has a PPS surface smoothness <3 μm as determined according to ISO 8791-4:2007.

### TECHNICAL FIELD

The present disclosure relates to paperboard-based disposable cups. More specifically, the present disclosure relates to paperboard-based disposable beverage cups suitable for serving beer.

### BACKGROUND

In large events such as outdoor festivals, beer is commonly served in plastic disposable cups. However, environmental concerns and changing legislation have caused strong pressure to reduce the use of plastic disposable items. However, the problem of excessive foaming with the current paperboard-based cups limits their potential to replace plastic beer cups.

Coating of paper and paperboard with plastics is often employed to combine the mechanical properties of the paperboard with the barrier and sealing properties of a plastic film. Paperboard provided with even a relatively small amount of a suitable plastic material can provide the properties needed to make the paperboard suitable for many demanding applications, for example as liquid or food packaging board. In liquid or food packaging board, polyolefin coatings are frequently used as liquid barrier layers, heat sealing layers and adhesives.

The foaming tendency of beer often limits the usage of paperboard-based disposable cups in beer serving. Due to excessive foaming, the filling of the cup takes too much time compared to glass or plastic beer cups. Especially in large festivals and similar events, filling of the cup must be done in a very short time. A typical requirement is that a cup should be fillable in 20 seconds with 400 ml of beer without overflowing. This requirement is not met with the current 2PE (double polyethylene coating layer) paperboard-based cups. For example, the paperboard cups must be filled with beer so slowly that the current automatic tap machines are not suitable without modification, which affects the volume of beer that can be sold.

Previous attempts to solve the problems with excessive foaming of beer in paperboard-based disposable cups have for example included adding surfactants to the polymer coating forming the inner surface of the cup. However, adding additional components to the surface intended for contact with the beverage to be consumed is generally undesired.

Thus, there remains a need for improved solutions to replace plastic disposable cups with paperboard-based disposable cups while avoiding the problems with excessive foaming in beer serving.

### DESCRIPTION OF THE INVENTION

It is an object of the present disclosure to provide a paperboard-based disposable cup with reduced foaming in beer serving.

It is a further object of the present disclosure, to provide a paperboard-based disposable cup with reduced foaming in beer serving using only components conventionally used in paperboard-based disposable cups.

The above-mentioned objects, as well as other objects as will be realized by the skilled person in the light of the present disclosure, are achieved by the various aspects of the present disclosure.

According to a first aspect illustrated herein, there is provided a paperboard-based disposable cup, said paperboard-based disposable cup being formed of a paperboard-based laminate,
wherein a first side of the paperboard-based laminate forming an inside surface of the paperboard-based disposable cup comprises
a pigment coating layer having a grammage in the range of 10-20 g/m² and
an outermost polymer coating layer having a grammage in the range of 5-25 g/m²,
wherein the inside surface of the paperboard-based disposable cup has a PPS surface smoothness <3 μm as determined according to ISO 8791-4:2007.

Surprisingly, the surface energy of board was found to had very little effect on foam formation. Instead, the smoothness of the inside surface of the cup was found to be the key factor influencing the foam formation. The present invention is based on the understanding that by providing a pigment coating layer underneath the outermost polymer coating layer forming the inside surface of the cup, a very smooth surface of the inside surface can be obtained. The smooth surface, having a PPS surface smoothness <3 μm as determined according to ISO 8791-4:2007, has been found to significantly reduce the foaming tendency of beer served in the cup.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements. The paperboard substrate used in the inventive method typically has a grammage of at least 100 g/m² and a density in the range of below 600-1000 kg/m³. Unless otherwise stated, the grammage is determined according to the standard ISO 536.

Unless otherwise stated, the density is determined according to the standard ISO 534. In some embodiments, the paperboard-based laminate of the paperboard-based disposable cup comprises a paperboard substrate having a grammage in the range of 150-400 g/m². In some embodiments, the paperboard substrate has a bulk >1.1 m³/kg, preferably >1.2 m³/kg, and more preferably >1.3 m³/kg, as determined according to ISO 534.

The paperboard may be a single ply material, or a multi-ply material comprised of two or more plies.

In some embodiments, the paperboard substrate is a multi-ply paperboard. In some embodiments the paperboard substrate is a multi-ply paperboard comprised of two or more plies. In some embodiments the paperboard substrate is a multi-ply paperboard comprised of three or more plies.

A common type of multi-ply paperboard is comprised of a lower density mid-ply (also sometimes referred to as “bulk ply”) sandwiched between two higher density outer plies. The lower density mid-ply may typically have a density below 750 kg/m³, preferably below 700, below 650, below 600, below 550, below 500, below 450, below 400 or below 350 kg/m³. The higher density outer plies typically have a density at least 100 kg/m³ higher than the mid-ply, preferably at least 200 kg/m³ higher than the mid-ply.

The paperboard substrate typically comprises kraft pulp. In some embodiments, the paperboard substrate consists of kraft pulp. In some embodiments, the paperboard substrate consists of a mixture of kraft pulp and chemi-thermomechanical (CTMP) or other mechanical pulps. In embodiments comprising a lower density mid-ply sandwiched between two higher density outer plies the outer plies may preferably consist of kraft pulp and the mid-ply may preferably consist of a mixture of kraft pulp and chemi-thermomechanical (CTMP) or other mechanical pulps.

Due to its fibrous composition, the paperboard substrate may typically have a relatively rough surface. In some embodiments, the paperboard substrate has a PPS (Parker Print-Surf) surface smoothness >3 μm, typically >5 μm, as determined according to ISO 8791-4:2007.

A paperboard-based laminate is a packaging material formed mainly from a paperboard substrate. In addition to the paperboard substrate, the paperboard-based laminate comprises additional layers or coatings designed to improve the performance and/or appearance of the laminate.

The paperboard substrate of the paperboard-based disposable cup is provided on a first side thereof facing the inside of the cup with a pigment coating layer. A pigment coating is a coating comprising at least one pigment and at least one binder. The pigment and binder are typically applied to the surface of the paperboard substrate in the form of a liquid, preferably aqueous, dispersion, and subsequently dried to obtain the pigment coating layer.

The grammage of the pigment coating layer is in the range of 10-20 g/m². In some embodiments, the pigment coating layer has a grammage in the range of 13-15 g/m².

In some embodiments, the pigment coating layer comprises at least one pigment and at least one binder. In some embodiments, the pigment coating layer comprises 60-70 wt % pigment and 20-30 wt % binder based on dry weight.

In some embodiments, the pigment comprises calcium carbonate and a platy pigment, preferably selected from the group consisting of kaolin, talc or a mixture thereof.

The binder may comprise a single binder or a combination of binders. The binder may preferably comprise a water-dispersible or water-soluble binder, or a combination thereof. In some embodiments, the binder is a latex, preferably selected from the group consisting of styrene acrylic (SA) latex, styrene butadiene (SB) latex, or a mixture thereof.

The pigment coating layer may preferably be applied in at least two different coating steps with drying of the coated film between the steps. Thus, in some embodiments, the pigment coating layer consists of two or more sub-layers.

In some embodiments, the pigment coating layer comprises a precoat layer formed on the paperboard substrate and a topcoat layer formed on the precoat layer.

In some embodiments, the precoat layer has a grammage in the range of 5-15 g/m², preferably in the range of 6-12 g/m².

In some embodiments, the precoat layer comprises 75-95 wt % pigment and 5-25 wt % binder, based on dry weight.

In some embodiments, the pigment in the precoat layer is calcium carbonate or a mixture of calcium carbonate and talc.

In some embodiments, the topcoat layer has a grammage in the range of 5-15 g/m², preferably in the range of 6-9 g/m².

In some embodiments, the topcoat layer comprises 20-50 wt % pigment and 50-80 wt % binder, based on dry weight.

In some embodiments, the pigment in the topcoat layer is platy pigment selected from the group consisting of kaolin, talc or a mixture thereof.

In some embodiments, the platy pigment in the topcoat layer has an aspect ratio above 10 and preferably above 20.

The pigment coating layer may also be calendered, preferably in a soft calender or belt calender.

In some embodiments, the pigment coating layer has a PPS surface smoothness <2 μm, preferably <1.7 μm, and more preferably <1.5 μm, as determined according to ISO 8791-4:2007.

The paperboard-based laminate is further provided with an outermost polymer coating layer formed on the pigment coating layer. The outermost polymer coating layer preferably provides liquid barrier properties and mechanical protection for the paperboard-based laminate surface. The outermost polymer coating layer is preferably also heat-sealable.

The outermost polymer coating layer is preferably applied onto the pigment coating layer by extrusion coating. Extrusion coating is a process by which a molten plastic material is applied to a substrate to form a very thin, smooth and uniform layer. I.e., in a preferred embodiment, the outermost polymer coating layer is an outermost extrusion coated polymer layer.

The outermost polymer coating layer may comprise any of the thermoplastic polymers commonly used in protective and/or heat-sealable layers in paperboard-based packaging laminates in general or polymers used in liquid or food packaging board in particular. Examples include polybutylene succinate (PBS), poly(butylene succinate-co-butylene adipate) (PBSA), polycaprolactone (PCL), poly(glycolic acid) (PGA), polyvinyl alcohol (PVOH), polybutylene adipate terephthalate (PBAT), polylactic acid (PLA), polyhydroxyalkanoates (PHA), polyhydroxybutyrate (PHB), starch, thermoplastic starch (TPS), cellulose acetate (CA), polyethylene (PE), polyethylene terephthalate (PET), polybutylene terephthalate (PBT), polytrimethylene terephthalate (PTT), polyethylene furanoate (PEF), polypropylene (PP), polyamide 6 (PA6), polyamide 66 (PA66), polyamide 11 (PA11), polyamide 12 (PA12), polyamide 10.10 (PA10.10), and polyamide 6.10 (PA6.10). Preferred examples include polyethylene (PE), polyethylene terephthalate (PET), polyethylene furanoate (PEF), polypropylene (PP), polyhydroxyalkanoates (PHA), polylactic acid (PLA), polyglycolic acid (PGA), polyvinyl alcohol (PVOH), and starch. Polyethylenes, especially low density polyethylene (LDPE) and high density polyethylene (HDPE), are the most common and versatile polymers used in liquid or food packaging board. In some embodiments, the outermost polymer coating layer comprises polyethylene, preferably low-density polyethylene (LDPE). The polymers used are preferably manufactured from renewable materials.

Alternatively, the outermost polymer coating layer is applied onto the pigment coating layer by liquid coating methods. In some embodiments, the polymer is applied in the form of a dispersion, latex or solution of the of the polymer in a liquid carrier, and subsequently dried to form the outermost polymer coating layer. The outermost polymer coating layer applied by liquid coating methods may be applied by contact or non-contact coating methods. Examples of useful coating methods include, but are not limited to rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating. In preferred embodiments the liquid dispersion is applied by blade coating.

The polymer applied in the form of a dispersion, latex or solution of the of the polymer in a liquid carrier may for example be selected from the group consisting of a latex (e.g. styrene-acrylate (SA) latex, styrene-butadiene (SB) latex, or mixtures thereof), starch, carboxymethyl cellulose (CMC), polyolefins (e.g. polyethylene (PE), polypropylene (PP), or copolymers of polyethylene and polypropylene), polyhydroxyalkanoates (PHA), polyhydroxybutyrate (PHB), and polylactic acid (PLA).

In some embodiments, the outermost polymer coating layer further comprises 1-20 wt % of a pigment, based on dry weight.

The grammage of the outermost polymer coating layer is in the range of 5-25 g/m². In some embodiments, the outermost polymer coating layer has a grammage in the range of 9-15 g/m².

Thanks to the underlying pigment coating layer, the outermost polymer coating layer has a very smooth surface. More specifically, the outermost polymer coating layer forming an inside surface of the paperboard-based disposable cup has a PPS surface smoothness <3 μm as determined according to ISO 8791-4:2007.

In some embodiments, the inside surface of the paperboard-based disposable cup has a PPS surface smoothness <2 μm, preferably <1.9 μm, and more preferably <1.8 μm, as determined according to ISO 8791-4:2007.

The second side of the paperboard-based laminate forming an outside surface of the paperboard-based disposable cup may also be provided with one or more coating layers, e.g. for improving the moisture resistance or printability of the outside surface of the paperboard-based disposable cup.

In some embodiments, the second side of the paperboard-based laminate forming an outside surface of the paperboard-based disposable cup comprises a pigment coating layer having a grammage in the range of 5-50 g/m².

In some embodiments, the second side of the paperboard-based laminate forming an outside surface of the paperboard-based disposable cup comprises an outermost extrusion coated polymer layer, preferably a polyethylene layer, having a grammage in the range of 5-50 g/m².

The paperboard-based disposable cup is intended for serving beverages in general, and beer in particular. In some embodiments, the paperboard-based disposable cup has an inner volume in the range of 50-2000 ml.

According to a second aspect illustrated herein, there is provided a method for manufacturing a paperboard-based disposable cup, said method comprising:
a) manufacturing a paperboard-based laminate by
   i. providing a paperboard substrate,
   ii. applying a liquid dispersion comprising a pigment and a binder onto a first side of the paperboard substrate and drying the applied liquid dispersion to obtain a pigment coating layer having a grammage in the range of 10-20 g/m² and a PPS surface smoothness <2 μm, preferably <1.7 μm, and more preferably <1.5 μm, as determined according to ISO 8791-4:2007,
   iii. applying a polymer layer by extrusion or liquid coating methods onto the pigment coating layer to obtain an outermost polymer coating layer having a grammage in the range of 5-25 g/m² and a PPS surface smoothness <3 μm as determined according to ISO 8791-4:2007; and
b) converting the paperboard-based laminate into a paperboard-based disposable cup, wherein the outermost polymer coating layer forms an inside surface of the paperboard-based disposable cup.

The paperboard substrate, the pigment coating layer, and the outermost polymer coating layer may be further defined as described above with reference to the first aspect.

In some embodiments, the pigment coating layer is formed by applying a first liquid dispersion comprising a pigment and a binder onto a first side of the paperboard substrate and drying the applied first liquid dispersion to obtain a precoat layer, and applying a second liquid dispersion comprising a pigment and a binder onto the precoat layer and drying the applied second liquid dispersion to obtain a topcoat layer on the precoat layer. The composition and grammage of the precoat layer and the topcoat layer may be the same or different. The composition and grammage of the precoat layer and the topcoat layer may be further defined as described above with reference to the first aspect.

The liquid dispersion may be applied by contact or non-contact coating methods. Examples of useful coating methods include, but are not limited to rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating. In preferred embodiments the liquid dispersion is applied by blade coating.

The polymer applied in iii. Is preferably applied by extrusion coating. The surface of the cooling cylinder used in the extrusion coating should preferably be smooth. In some embodiments, the cooling cylinder used in the extrusion coating is chromium-plated. In some embodiments, the cooling cylinder used in the extrusion coating is highly polished. In some embodiments, the surface of the cooling cylinder used in the extrusion coating has an average roughness (Ra) of <0.25 μm, preferably <0.10 μm, and more preferably <0.025 μm. In some embodiments, the cooling cylinder used in the extrusion coating is of the “GLF” type. In some embodiments, the cooling cylinder used in the extrusion coating is of the mirror finish or mirror pocket type.

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

### Example—Beer Pouring Test

The equipment used in the pouring test involved a laboratory stand and two clamps. An opened 330 ml beer can containing lager beer was attached to the upper clamp horizontally. A 75 mm glass funnel was attached to the lower clamp to simulate the mouth of a beer tap. The final pouring angle was adjusted so that the 330 ml beer can ran empty in 17 seconds. The time was confirmed with a stopwatch. This time was selected based on the assumption that a commercial beer tap fills the cup with 400 ml of beer in 20 seconds. The distance between the bottom part of the beer can and the top part of the glass funnel was approx. 30 mm in the setup. The temperature of beer was 4 °C in the experiment.

A 500 ml disposable plastic (PP) beer cup was used as reference sample. The 500 ml disposable plastic beer cup was placed under the outlet of the glass funnel. The distance between the outlet and the internal wall of the cup was approx. 30-40 mm. The cup was positioned in an angle of 20° to the flat table surface with the aid of plastic support placed under the cup. The beer was first in contact with the cup wall, not the cup bottom as in a typical beer tap setup. The number of parallel determinations was three.

The same procedure was then repeated with different types of coated paperboard as the inside surface of the cup as set out in Table 1. The paperboards included three different standard polymer coated boards, and two different boards according to the proposed inventive concept. The internal wall of a plastic cup was covered prior to the pouring test with the paperboard substrate. The height of foam and liquid matrices was marked on the outer surface of the cup after immediate removal of the paperboard cover inside the cup. The whole pouring test was recorded with a video camera to ensure the quality of documentation of beer foaming behavior.

The properties and phenomena that were followed during the experiment included: i) the height of formed foam layer, ii) the structure of the foam (lamellar or not) and iii) potential occurrence overfoaming. The presence of lamellar foam is theoretically desired because it indicates rapid degradation of foam and thus less risk of overfoaming. In addition, the PPS (Parker Print-Surf) surface smoothness of each inside surface was determined according to ISO 8791-4:2007 (1.0 MPa).

TABLE 1

| | Over- | Height | | Lamellar | |
|---|---|---|---|---|---|
| | foaming | of foam | | foam | PPS 1.0 |
| Product | occurred | layer, cm | | visible | MPa, μm |
| Reference, | No | 7 | cm | No | n.d. |
| plastic (PP) | | | | | |
| disposable | | | | | |
| beer cup | | | | | |
| 500 ml | | | | | |
| Reference, | Yes | >10 | cm | Yes | 4.87 |
| standard 2PE | | | | | |
| paperboard | | | | | |
| 12 + 15 gsm PE | | | | | |
| Reference, | Yes | >10 | cm | Yes | 10.7 |
| standard 2PP | | | | | |
| coated board | | | | | |
| 30 + 30 gsm PP | | | | | |
| Reference, | Yes | 10 | cm | Yes | 5.09 |
| standard | | | | | |
| board, 1PE, | | | | | |
| 15 gsm PE | | | | | |
| Proposed | No | 8 | cm | Yes | 1.83 |
| concept, 2PE, | | | | | |
| PE 12 gsm on | | | | | |
| top of pigment | | | | | |
| coating + | | | | | |
| PE 15 gsm | | | | | |
| Proposed | No | 6 | cm | No | 1.71 |
| concept, 2PE, | | | | | |
| PE 20 gsm on | | | | | |
| top of pigment | | | | | |
| coating + | | | | | |
| PE 35 gsm | | | | | |

Notes:
>10 cm foam means that the overfoaming was so strong that it was impossible to determine the initial height of foam layer. 10 cm was still somewhat measurable and overfoaming was not heavy.

1. A paperboard-based disposable cup, said paperboard-based disposable cup being formed of a paperboard-based laminate,
wherein a first side of the paperboard-based laminate forming an inside surface of the paperboard-based disposable cup comprises
a pigment coating layer having a grammage in a range of 10-20 g/m², and
an outermost polymer coating layer having a grammage in a range of 5-25 g/m²,
wherein the inside surface of the paperboard-based disposable cup has a PPS surface smoothness <3 μm as determined according to ISO 8791-4:2007.

2. The paperboard-based disposable cup according to claim 1, wherein the paperboard-based laminate comprises a paperboard substrate having a PPS surface smoothness >3 μm, as determined according to ISO 8791-4:2007.

3. The paperboard-based disposable cup according to claim 1, wherein the pigment coating layer has a grammage in a range of 13-15 g/m².

4. The paperboard-based disposable cup according to claim 1, wherein the pigment coating layer comprises at least one pigment and at least one binder.

5. The paperboard-based disposable cup according to claim 1, wherein the pigment coating layer comprises 60-70 wt % pigment and 20-30 wt % binder, based on a dry weight.

6. The paperboard-based disposable cup according to claim 4, wherein the at least one pigment comprises calcium carbonate and a platy pigment.

7. The paperboard-based disposable cup according to claim 4, wherein the at least one binder is a latex.

8. The paperboard-based disposable cup according to claim 1, wherein the pigment coating layer comprises consists of two or more sub-layers.

9. The paperboard-based disposable cup according to claim 8, wherein the pigment coating layer comprises a precoat layer formed on a paperboard substrate of the paperboard-based laminate and a topcoat layer formed on the precoat layer.

10. The paperboard-based disposable cup according to claim 9, wherein the precoat layer has a grammage in a range of 5-15 g/m².

11. The paperboard-based disposable cup according to claim 9, wherein the precoat layer comprises 75-95 wt % pigment and 5-25 wt % binder, based on a dry weight.

12. The paperboard-based disposable cup according to claim 9, wherein the at least one pigment in the precoat layer is comprises calcium carbonate or a mixture of calcium carbonate and talc.

13. The paperboard-based disposable cup according to claim 9, wherein the topcoat layer has a grammage in a range of 5-15 g/m².

14. The paperboard-based disposable cup according to claim 9, wherein the topcoat layer comprises 20-50 wt % pigment and 50-80 wt % binder, based on a dry weight.

15. The paperboard-based disposable cup according to claim 9, wherein the at least one pigment in the topcoat layer is a platy pigment selected from a group consisting of: kaolin, talc, and a mixture thereof.

16. The paperboard-based disposable cup according to claim 15, wherein the platy pigment in the topcoat layer has an aspect ratio above 10.

17. The paperboard-based disposable cup according to claim 1, wherein the pigment coating layer has a PPS surface smoothness <2 μm, as determined according to ISO 8791-4:2007.

18. The paperboard-based disposable cup according to claim 1, wherein the inside surface of the paperboard-based disposable cup has a PPS surface smoothness <2 μm, as determined according to ISO 8791-4:2007.

19. A method for manufacturing a paperboard-based disposable cup, said method comprising:
a) manufacturing a paperboard-based laminate by
i. providing a paperboard substrate,
ii. applying a liquid dispersion comprising a pigment and a binder onto a first side of the paperboard substrate and drying the liquid dispersion to obtain a pigment coating layer having a grammage in a range of 10-20 g/m² and a PPS surface smoothness <2 μm, as determined according to ISO 8791-4:2007,
iii. applying a polymer coating layer onto the pigment coating layer to obtain an outermost polymer coating layer having a grammage in a range of 5-25 g/m² and a PPS surface smoothness <3 μm as determined according to ISO 8791-4:2007; and
b) converting the paperboard-based laminate into a paperboard-based disposable cup, wherein the outermost polymer coating layer forms an inside surface of the paperboard-based disposable cup.
